(19) United States
(12) Patent Application Publication
(10) Pub. No.: US 2016/0137908 A1
(43) Pub. Date: May 19, 2016

(54) Improved Suspension of Proppant Particles in Hydraulic Fracturing Liquid

(71) Applicant: HALLIBURTON ENERGY SERVICES, INC., Houston, TX (US)

(72) Inventors: Ali Alwattari, Humble, TX (US); Philip D. Nguyen, Houston, TX (US)

(73) Assignee: Halliburton Energy Services, Inc., Houston, TX (US)

(21) Appl. No.: 14/904,927

(22) PCT Filed: Aug. 30, 2013
(86) PCT No.: PCT/US2013/057616

§ 371 Date: Jan. 13, 2016

(51) Int. Cl. C09K 8/68; C09K 8/90; C09K 8/88; C09K 8/80; C09K 8/66

(52) U.S. Cl. CPC C09K 8/68; C09K 8/80; C09K 8/805; C09K 8/66; C09K 8/882; C09K 8/90; C09K 2208/04

(57) ABSTRACT

Systems and methods for suspending proppant particles are described. Systems and methods may include a composition including a hydraulic fracturing fluid, one or more proppant particles in the hydraulic fluid, and a density modifier associated with the one or more proppant particles to create one or more modified proppant particles. The association of the density modifier with the one or more proppant particles may modify the density of the one or more modified proppant particles relative to the one or more proppant particles.

### FIELD

The present disclosure relates to systems and methods for delivering proppant particles to a subterranean operation, and, more specifically, to systems and methods for reducing and/or eliminating settling of proppant particles in hydraulic fracturing fluid.

### BACKGROUND

A proppant is a solid material used to keep an induced hydraulic fracture open during or following a fracturing treatment. A proppant is typically treated sand or man-made ceramic material. Proppant particles are generally added to hydraulic fracturing fluid prior to pumping the fracturing fluid downhole. The fracturing fluid is pumped at high pressure into the desired formation downhole. The proppant may enter the fractures in the formation and hold the fracture open after the fracturing pressure is removed. Typically, it takes approximately 7-10 minutes for fracturing fluid to travel from the surface to fractures within a desired downhole formation. During this time, proppant particles may settle out of suspension in the fracturing fluid.

Fracturing fluid may vary in composition. To maintain suspension of the proppant particles in the fracturing fluid, most current systems increase viscosity of the fracturing fluid by addition of compounds, such as polymers. This increase in viscosity increases the amount of time the proppant particles remain in suspension, but also increases the energy required to pump the fracturing fluid into the formation.

### DETAILED DESCRIPTION OF THE PREFERRED EMBODIMENTS

Systems and methods are described for replacements and/or alternatives to delivering proppant particles into a fracture with gelled fracturing fluids. Certain embodiments may also be used in combination with gelled fracturing fluids. Embodiments may improve suspension of proppant particles in hydraulic fracturing fluid. The systems and methods described herein may be applied in oilfield drilling applications or for other situations where controlling flow of materials into or out of a wellbore are advantageous. Certain embodiments may provide a combination of reduced pumping requirements, an ability to easily move solid particles into a formation, a slowed settling process for solid particles, reduced viscosity of pumped fluid, etc. The examples described herein relate to proppants within fracturing fluids for illustrative purposes only. In alternate embodiments, the systems and methods may be used wherever decreasing viscosity or improving flow into or out of a location is desirable.

In certain embodiments, proppant particles may be treated to increase the amount of time the proppant particles are suspended in the fracturing fluid and/or reduce or eliminate settling of the proppant particles in the fracturing fluid. Lower density proppant particles may result in slower settling. The proppant particles may be treated to change the density of the proppant particles. In certain embodiments, the treated proppant particles may have approximately neutral buoyancy in the suspension fluid. Density of the proppant particles may be varied based on fracturing fluid, environmental conditions, etc. By not being dependent on the viscosity of the fracturing fluid, less or no polymer is required in the carrier fluid. Therefore, the carrier fluid may be more easily pumped downhole, reducing operating costs.

In certain embodiments, the density of the proppant particles is changed by adding an additional material or even a structure around a proppant particle. The additional structure may at least partially surround the proppant particle. In certain embodiments, the additional structure is not a coating. Fluid is displaced to keep the proppant particle suspended. In certain embodiments, the proppant particles are modified prior to suspension within a hydraulic fracturing fluid. Settling of proppant particulates may be reduced when low density particles are added to high density particles, such as a combination of approximately 75% sand and approximately 25% nylon/TEFLON/polyethylene.

The fracturing fluid base may be any acceptable fracturing fluid base for a fracturing fluid such as, but not limited to, water, oil, brine, acids, and combinations thereof. Existing fracturing fluids may be used in embodiments described herein.

Any particulate suitable for use in subterranean applications is suitable for use as proppant particles in the compositions and methods of the present invention. For instance, natural sand, quartz sand, particulate garnet, glass, ground nut hulls, such as walnut, nylon pellets, bauxite, ceramics, polymeric materials, carbon composites, natural or synthetic polymers, porous silica, alumina spheroids, and resin beads are suitable. Suitable sizes range from 4 to 100 U.S. mesh, in certain preferred embodiments the sizes range from 10 to 60 U.S. mesh. The particulates may be in any form, including that of regular or irregular pellets, fibers, spheres, flakes, ribbons, beads, shavings, platelets and the like. One skilled in the art, with the benefit of this disclosure, will be able to select a size and shape particulate appropriate for the subterranean operation being performed.

Density may be modified in various ways by adding one or more components to the proppant particles.

In certain embodiments, a pure molten material or a waterborne latex or combinations thereof may be used to make a low density coating around proppant particles. Suitable materials may include, but are not limited to aerated waxes, silica aerogel, polystyrene grafted directly onto sand, acrylic/acrylate latex, styrene/butadiene latex, polyurethane latex, and combinations thereof. Proppant particles may be coated in batch processes, partial batch processes, and/or on-the-fly processes. In certain methods, the treated proppant particles may be prepared offsite. In other embodiments, the treated proppant particles may be prepared onsite, such as by dry blending. One skilled in the art, with the benefit of this disclosure, will be able to select a process appropriate for the subterranean operation being performed.

The molten material or latex may be used with a foaming agent (volatile) to make a low density coating around the proppant particles. The molten material or latex may be used in combination with mechanically entrained gas, such as air, to make a low density coating around the proppant particles. Mechanically entrained air may be, but is not limited to, tar forced through aerated baffles.

A low density prefoamed polymer may be used to reduce the density of the proppant particles. In certain embodiments, prefoamed polymers may be formed by processes known to one of ordinary skill in the art. In certain embodiments, air, carbon dioxide or other gases, may be impregnated into a polymer by blowing a volatile agent into a monomer, polymer, or liquid coating that conforms to a particular shape. The polymer particles may then be dispersed into a dispersion medium in a sealed vessel. The polymer particles may be heated or pressurized to a temperature higher than the softening point of said polymer particles. One end of said vessel may be opened while simultaneously releasing the polymer particles and dispersion medium from inside the vessel to an atmosphere at a pressure lower than that of the vessel. These various steps may be performed in one or more vessels.

With a volume ratio of foam or low density particles:proppant particulates between approximately 0.1:10 to approximately 10:0.1, preferably greater than approximately 0.5:1, a hydrophobic coating may be light weight and delay or prevent settling of proppant particles. This may reduce the need for a gelling agent or thick, hard to pump carrier phase for proppant to enter fractures and prolong the open or cracked state of a gas or oil field. Coal tar foam, similar to what is used as a topical psoriasis skin therapy at greater than approximately 2% may be used as a coating formulation. Self-foaming compositions may be beneficial in various embodiments. Foams may provide appropriate rheology if there is a high enough volume and appropriate space filling.

In certain embodiments, a tacky film may be applied to the proppant particles prior to exposing the coated proppant particles to low density particulates. The tacky film may at least partially surround the proppant particles. Compounds suitable for use as a tacky film may include substantially any compound that, when in liquid form or in a solvent solution, may form a non-hardening coating upon a particulate. A particularly preferred group of tacky films may include polyamides that are liquids or in solution at the temperature of the subterranean formation such that the polyamides are, by themselves, sticky and yet non-hardening. A particularly preferred product may be a condensation reaction product of commercially available polyacids and a polyamine Such commercial products may include compounds such as mixtures of long chain dibasic acids, preferably C₃₆ dibasic acids, containing some trimer and higher oligomers and also small amounts of monomer acids that are reacted with polyamines Other polyacids may include trimer acids, synthetic acids produced from fatty acids, maleic anhydride and acrylic acid and the like. Such acid compounds are commercially available from companies such as Witco Corporation, Union Camp, Chemtall, and Emery Industries. The reaction products are available from, for example, Champion Technologies, Inc. and Witco Corporation. Additional compounds that may be utilized as tacky films may include liquids and solutions of, for example, polyesters, polycarbonates and polycarbamates, natural resins such as shellac and the like. Suitable tacky films are described in U.S. Pat. No. 5,853,048 issued to Weaver, et al. and U.S. Pat. No. 5,833,000 issued to Weaver, et al., the relevant disclosures of which are herein incorporated by reference.

Low density particulates may include, but are not limited to, hollow glass microbeads, polystyrene microbeads, etc.

The low density particulates may be a plurality of low-density micro-material, smaller in size than the particulate itself Such low density particulates may be any low density particulates suitable for use in subterranean applications. In certain embodiments, the low density particulates may be particulates that is on average less than about half the size of the proppant particles. While low density particulates suitable for use in the present invention may be essentially spherical in shape, that geometry is not essential; they may be in any form, including that of regular or irregular pellets, fibers, spheres, flakes, ribbons, beads, shavings, platelets and the like. The term “low-density” as used herein refers to a material having a low specific gravity as compared with a conventional proppant particulate, such that when associated with such a proppant particulate, the material contributes to reducing the overall density of the particulate.

In some embodiments, the low density particulates used may be a synthetic, non-porous microsphere. Such microspheres may be obtained from any suitable source. Particularly suitable microspheres may be cenospheres, which are hollow microspheres formed as an industrial waste by-product, and which are commercially available from, for example, Halliburton Energy Services, Inc., of Duncan, Okla., under the trade name “SPHERELITE.” Generally speaking, the micro-material may be included with the proppant particulates in an amount suitable to alter the density of the proppant particulates as desired. In some embodiments, the micro-material may be present in an amount from about 1% by weight of the particulate to about 100% by weight of the particulates, preferably from about 10% to about 30% by weight of the particulates.

In another embodiment, the low density particulates may be low-density material similar in size to the particulate itself. Suitable materials may include any solid material that is, on average, greater than about half the size of the proppant particulates and having a low specific gravity as compared with the proppant particulates, such that when adhered to the particulates, they contribute to altering the overall density as desired. As with suitable low-density micro-materials, while low-density materials may be essentially spherical in shape, that geometry is not essential, they may be in any form, including that of regular or irregular pellets, fibers, spheres, flakes, ribbons, beads, shavings, platelets and the like. Examples of these low-density materials may be polystyrene divinylbenzene plastic beads from suppliers such as ATS Incorporated, Dow Chemical, Sun Drilling Products, etc. These particular polystyrene divinylbenzene plastic beads are commercially available, for example, as a lubrication or torque reduction aid for drilling fluids from ATS Incorporated under the brand name “AT SLIDE (FINE),” or from Sun Drilling Products under the brand name “LUBRAGLIDE,” or as an ion exchange beads manufactured by Dow Chemical.

The surface of one or more proppant particles may be at least partially covered by the low density particulates attached to the proppant particles. The modified proppant particles may be prepared on the fly at the well site or offsite. The low density particulates may be loosely adhered to the proppant particles. Air may be entrained to reduce density of the overall treated proppant particles.

Proppant particles and low density particulates must withstand widely varying operating parameters. Proppant particles and low density particulates may be chosen based on specific operating parameters. Typical hydraulic pressure in a drilling operation is approximately 8-10 k psi. Typical mechanical pressure in a formation is approximately 2-15 k psi. The proppant particles and/or the low density particulates may be chosen to withstand the appropriate amount of force without rupturing. In certain embodiments, the proppant may carry most or all of the closure stress of the closing fracture. The low density particulates may primarily function to alter the apparent density of the proppant particles.

In certain embodiments, the low density particulates may be degradable. The particulates may be degradable over time under downhole conditions. Alternatively, they may be degradable by addition of an additive to the fracturing fluid or degradable under other conditions. Biofoams prepared from polyethylene (PE), polylactic acid (PLA), polyglycolic acid (PGA), polyethylene terephthalate (PET), starch, guar, etc. may be used. Methods of preparing biofoams are well-known to one of ordinary skill in the art.

Embodiments may be used in water-containing areas without being significantly changed or affected as the modified proppant particles may not be hydratable. The low density foamed coating on the proppant particles may be hydrophobic.

Embodiments described herein may allow for fewer components in a fracturing fluid composition. Less or no polymer may be required in hydraulic fracturing fluid compositions. Surface adhesion of the proppant particles to pores and rock may be improved. Similarity of the structured waterproof coating may make it more similar to surrounding substrata than a completely synthetic water soluble polymer.

Use in a natural gas environment may allow a “foamy tar” coating to absorb and expand in the presence of natural gas making the fracture more durable and larger in size and/or volume. The foamy tar may expand while under pressure, in the well hole, or at the well head. Exemplary foamy tar compositions may be hydrocarbon polymers, such as, but not limited to, polystyrene, polyethylene, polypropylene, rubber, and combinations thereof.

All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values.

Although the foregoing description is directed to the preferred embodiments of the disclosure, it is noted that other variations and modifications will be apparent to those skilled in the art, and may be made without departing from the spirit or scope of the disclosure. Moreover, features described in connection with one embodiment of the disclosure may be used in conjunction with other embodiments, even if not explicitly stated above.

What is claimed is:

1. A composition for improving suspension of proppant particles, the composition comprising:
hydraulic fracturing fluid;
one or more proppant particles within the hydraulic fracturing fluid; and
a density modifier associated with the one or more proppant particles to create one or more modified proppant particles, wherein the association of the density modifier with the one or more proppant particles modifies the density of the one or more modified proppant particles relative to the one or more proppant particles.

2. The composition of claim 1, wherein the hydraulic fracturing fluid is selected from the group consisting of: water, oil, brine, acids, and combinations thereof.

3. The composition of claim 1, wherein the one or more proppant particles are selected from the group consisting of: natural sand, quartz sand, particulate garnet, glass, ground walnut hulls, nylon pellets, bauxite, ceramics, polymeric materials, carbon composites, natural or synthetic polymers, porous silica, alumina spheroids, resin beads, and combinations thereof.

4. The composition of claim 1, wherein the density modifier is a molten material or latex in combination with a foaming agent.

5. The composition of claim 1, wherein the density modifier is mechanically entrained air.

6. The composition of claim 1, wherein the density modifier is a tacky film at least partially surrounding the one or more proppant particles, and one or more low density particulates coupled to the tacky film.

7. The composition of claim 6, wherein the one or more low density particulates at least partially surround the one or more proppant particles.

8. The composition of claim 1, wherein the density modifier is a foamy tar coating.

9. The composition of claim 8, wherein the foamy tar coating is selected from the group consisting of: polystyrene, polyethylene, polypropylene, rubber, and combinations thereof.

10. The composition of claim 8, wherein the foamy tar coating expands in the presence of natural gas while under pressure, in the well hole, or at the well head.

11. A method for improving suspension of proppant particles in hydraulic fracturing fluid, the method comprising:
providing one or more proppant particles in a hydraulic fracturing fluid;
modifying the one or more proppant particles by associating a density modifying component with the one or more proppant particles to create one or more modified proppant particles; and
providing the hydraulic fracturing fluid with the one or more modified proppant particles to a downhole formation.

12. The method of claim 11, wherein the hydraulic fracturing fluid is selected from the group consisting of: water, oil, brine, acids, and combinations thereof.

13. The method of claim 11, wherein the one or more proppant particles are selected from the group consisting of: natural sand, quartz sand, particulate garnet, glass, ground nut hulls, nylon pellets, bauxite, ceramics, polymeric materials, carbon composites, natural or synthetic polymers, porous silica, alumina spheroids, resin beads, and combinations thereof.

14. The method of claim 11, wherein the density modifying component is a molten material or latex in combination with a foaming agent.

15. The method of claim 11, wherein the density modifying component is mechanically entrained air.

16. The method of claim 11, wherein the density modifying component is a tacky film at least partially surrounding the one or more proppant particles, and one or more low density particulates coupled to the tacky film.

17. The method of claim 16, wherein the one or more low density particulates at least partially surround the one or more proppant particles.

18. The method of claim 11, wherein the density modifying component is a foamy tar coating.

19. The method of claim 18, wherein the foamy tar coating is selected from the group consisting of: polystyrene, polyethylene, polypropylene, rubber, and combinations thereof.

20. The method of claim 18, wherein the foamy tar coating expands in the presence of natural gas while under pressure, in the well hole, or at the well head.
